(19) United States
(12) Patent Application Publication
(10) Pub. No.: US 2022/0032465 A1
(43) Pub. Date: Feb. 3, 2022

(54) NON-INTRUSIVE AUTOMATED TEST BENCH, INTENDED TO PERFORM MECHANICAL AND/OR SOFTWARE AND/OR VISUAL AND/OR AUDIO TESTS ON THE HUMAN-MACHINE INTERFACE OF AN APPARATUS/DEVICE

(71) Applicant: PONANT TECHNOLOGIES, VALENCE (FR)

(72) Inventors: Christophe BARTHELEMY, MONTMEYRAN (FR); Thomas LE GAL, VALENCE (FR); Antoine DESSALES, VALENCE (FR)

(21) Appl. No.: 17/278,829

(22) PCT Filed: Sep. 23, 2019
(86) PCT No.: PCT/EP2019/075565

§ 371 Date: Mar. 23, 2021

(30) Foreign Application Priority Data
Sep. 24, 2018 (FR) 1858627

(51) Int. Cl. B25J 9/16; B25J 9/02; B25J 19/02

(52) U.S. Cl. CPC B25J 9/1679; B25J 9/023; B25J 19/026; B25J 19/023; B25J 9/1697

(57) ABSTRACT

A non-intrusive automated test bench intended to perform mechanical and/or software and/or audio tests on one or more human-machine interfaces of an apparatus/device. Such a test bench makes it possible, in replacing an operator, to carry out mechanical and/or software and/or audio test sequences on one or more HMI of any apparatus/device, in its operational version, i.e., without needing to implement intrusive software and/or modifications and mechanical arrangements specifically dedicated to an apparatus/device, etc.

### TECHNICAL FIELD

The present invention relates to the field of automated test benches for apparatuses/devices.

It aims to improve on existing test benches by providing a non-intrusive, automated test bench intended to perform mechanical and/or software and/or visual and/or audio tests on the human-machine interface of an apparatus/device.

The automated test bench according to the invention is more particularly intended for non-intrusive tests on electronic devices provided with a human-machine interface consisting of a screen and a keyboard. In the case of a touchscreen, the physical screen might or might not be completely merged with the keyboard.

The applications of a test bench according to the invention are numerous. They particularly relate to the testing of consumer or professional devices for which the test conditions must be similar to the operating conditions and for which quality and reliability are important features of the apparatus/device.

Among the apparatuses/devices targeted by the invention, mention may be made of smartphones, weight indicators, payment terminals, instrument panels or subassemblies of instrument panels, portable medical instruments, etc.

### PRIOR ART

The solutions for the automated testing of human-machine interfaces of apparatuses/devices that currently exist may be classified according to different categories.

The tests that have to be performed are functional or endurance tests implementing the keyboard and/or the screen and/or the software application as standard of the apparatus/device with respect to the external environment.

The first category relates to automatic benches dedicated specifically to the tests.

Thus, mechanical and software means are developed specifically for each new type of apparatus/device to be tested. The main drawback of this solution is clear: the means have to be developed anew for each new device or change to the device. Software facilitates this development, but such software remains restricted to computer scientists. Mention may be made here of the software with the trade name “LabView”.

Intrusive tests have also been implemented, as described in patent application EP0084454. In this case, dedicated software, the functions of which are to retrieve information on what is being displayed and also to simulate a press on a keyboard of the apparatus/device to be tested, is loaded into the apparatus/device. In this case, the testing may be automated without the implementation of external mechanical means. Apart from the fact that the apparatus/device is loaded with additional software, these intrusive tests have the main drawback of introducing test conditions that are not identical to the operating conditions of the device.

Test software specifically dedicated to human-machine interfaces has been developed. Such software is limited to testing applications to be used on the web, and is rarely usable for embedded software. Such software may be considered intrusive as it is not necessary for the operation of the apparatus/device. Reference may be made to the “Selenium” software, which is a computer testing “framework” developed in Java.

Lastly, there are functions for testing keyboards or screens. These functions allow physical testing to be performed but are limited to a keyboard or to a screen. The screen and keyboard combination is used for testing one of the subassemblies, as disclosed in patent applications EP2405356 and EP0175765. These solutions do not use the operating application of the apparatus/device but a dedicated application, and may therefore be considered intrusive.

There is therefore a need to improve on existing automated test benches in order to overcome the aforementioned drawbacks.

The aim of the invention is to at least partially address this need.

### DISCLOSURE OF THE INVENTION

To that end, one subject of the invention is a non-intrusive automated test bench, intended to perform mechanical and/or software and/or audio tests on one or more human-machine interfaces (HMI) of an apparatus/device, comprising

a support, designed to hold the apparatus to be tested in a fixed position, called the reference position, during at least one test of at least one sequence;

at least one probe, designed to come into contact with an acquisition interface (HMI) of the apparatus/device during the one or more tests;

at least one probe actuator, designed to move the probe in translation along at least one of the three axes (X, Y, Z), the actuator comprising a gantry forming a Cartesian robot with three axes (X, Y, Z), to which the probe is secured;

at least one microphone, designed to pick up the sounds emitted by at least one sound reproduction interface of the apparatus/device, during the one or more tests;

at least one camera, designed to take images and/or videos of the apparatus/device, more particularly of the one or more interfaces (HMI) for visual reproduction of the apparatus/device, during the one or more tests,

a central unit, designed to control the one or more probe actuators, the one or more microphones, in order to implement the one or more test sequences of the apparatus/device, and to process the images and/or videos of the apparatus, from the one or more cameras.

What is meant by “probe” here and in the context of the invention is a mechanical element that is intended to make contact with the apparatus/device to be inspected, which is mounted on a support finger that incorporates at least one device for adjustment along the axis Z. The arrangement of the probe and its actuator allow it to press in a region of the apparatus/device to be tested along an axis of movement which might not be perpendicular to the axis Z.

In particular, the probe can advantageously comprise at least one palpation protuberance, preferably a ring made of compressible material, which extends laterally with respect to the axis Z and which is designed to perform pressing actions in a region, in particular a convex region, at the edge of a main surface of the apparatus/device to be tested.

Preferably, the central unit of the test bench is configured to define exclusion regions into which the probe is not allowed to move along one and/or another of the three axes X, Y and Z.

Advantageously, the camera can be fixed or be secured to the gantry with three axes (X, Y, Z), in a plurality of orientations.

The test bench can advantageously comprise one or more cameras, advantageously complementary to one another. These complementary cameras can be designed to, respectively:

record, in real time, the actions performed by the test, which can make it possible to subsequently view, in particular, action and display sequences at the end of the test (post-mortem analysis);

analyze displays on a secondary HMI screen which is not covered or poorly covered by a camera positioned on the axis Z. This function is useful for devices to be tested that incorporate several screens positioned in non-parallel planes;

analyze displays continuously, including during movements of the axes X, Y and Z.

According to one advantageous embodiment, the test bench further comprises means for mechanical insertion and/or electrical connection and/or contactless reading of a component in the apparatus/device, such as a payment card or an electrical connector.

According to this embodiment, the mechanical insertion and/or electrical connection means can advantageously comprise at least one rail on which a carriage on which the component can be held is slidably mounted.

Again advantageously, the carriage bears a ring into which the shaft of the probe can be fitted so that the gantry can move the carriage on the rail via the probe.

According to one advantageous embodiment, the test bench further comprises lighting means for illuminating the support for the apparatus/device.

Preferably, the central unit is further designed to control the switching on, switching off and, where applicable, the adjustment of the intensity of the lighting means during the one or more sequences of one or more tests on the apparatus/device.

According to one advantageous variant, the test bench comprises at least one electrical power socket for the apparatus, the socket being designed to be controlled by the central unit during the one or more sequences of one or more tests on the apparatus/device.

According to another advantageous embodiment, the test bench comprises an enclosure comprising at least one secure access to the support for an operator from the outside, the enclosure being configured to house the support, the one or more probes and the one or more probe actuators, the one or more microphones, the one or more cameras and, where applicable, the gantry with three axes, and, where applicable, the means for mechanical insertion and/or electrical connection of a component in the apparatus/device, the lighting means for illuminating the support for the apparatus, and the one or more electrical power sockets for the apparatus/device.

Advantageously, the test bench comprises a frame to which are secured the central unit, the enclosure, an electrical box for controlling the central unit and an external connector, preferably a 220 V power supply connector and/or an Ethernet-type connector.

Another subject of the invention is the use of the automated test bench described above to perform at least one non-intrusive test in at least one sequence on an apparatus/device in particular chosen from a smartphone, an electronic payment terminal, a measurement or metrology indicator, an embedded medical device, an IOT object equipped with a screen and/or a keyboard, a device for an instrument panel, an interactive terminal, a connected watch, a portable video game console, a car radio, an industrial control panel.

Thus, the invention essentially consists of a non-intrusive, automated test bench that makes it possible, in replacing an operator, to carry out mechanical and/or software and/or audio test sequences on one or more human-machine interfaces (HMI) of any apparatus/device, in its operational version, i.e. without needing to implement intrusive software and/or modifications and mechanical means specifically dedicated to an apparatus/device, etc.

The operator is replaced for the functions of key pressing, of recognizing information displayed by a screen of the apparatus/device and by listening to the device.

All of the components (mechanical/software/visual/audio) are controlled by test software, the programming language of which is preferably as close as possible to the natural language of the operator. The test sequences are performed deterministically using simple language.

The advantages of the invention are numerous, among which may be mentioned:

replacing an operator for using a keyboard, for reading a screen and for listening to an audio indicator of an apparatus/device to be tested;

maintaining hardware and software integrity for the apparatus/device to be tested;

the possibility of executing deterministic test sequences which can be repeated over long periods and which would not be possible for an operator to perform;

the description of the test sequences by an operator in the language of their field and in a deterministic manner;

the possibility of using the test bench in any research-and-development or production facility without risk, by virtue of means for protecting the operator integrated into the test bench;

repeatability of the test sequences and their execution which provide the context of the test and help with diagnosis.

### DETAILED DESCRIPTION

Other advantages and features of the invention will become more clearly apparent from reading the detailed description of the invention, provided by way of non-limiting illustration with reference to the following figures, among which:

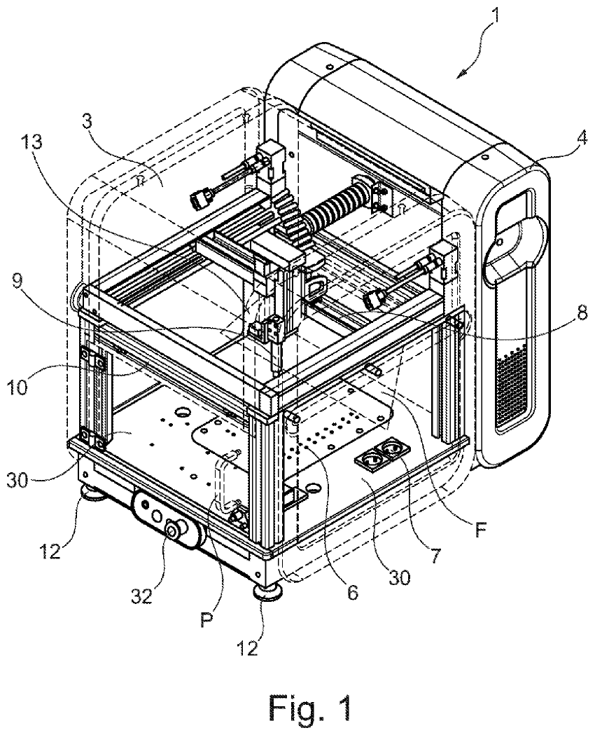

FIG. 1 is a see-through perspective view of an exemplary non-intrusive, automated test bench according to the invention;

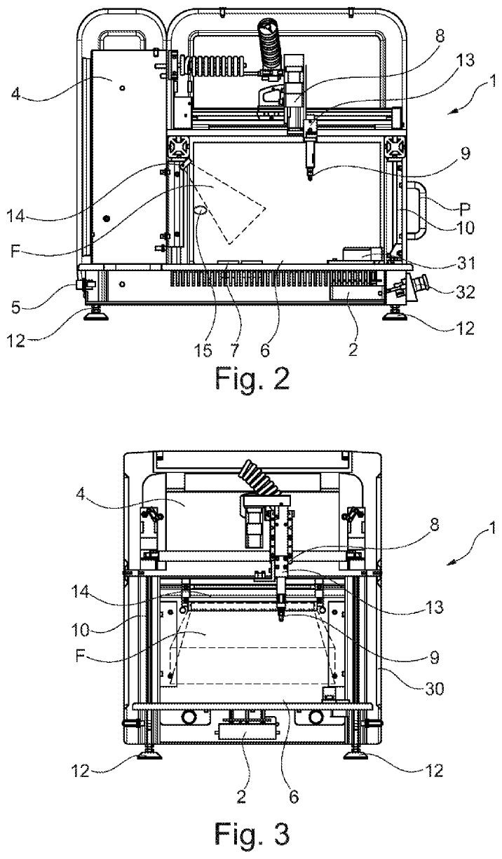

FIG. 2 shows a side view of the test bench according to FIG. 1;

FIG. 3 shows a front view of the test bench according to FIG. 1;

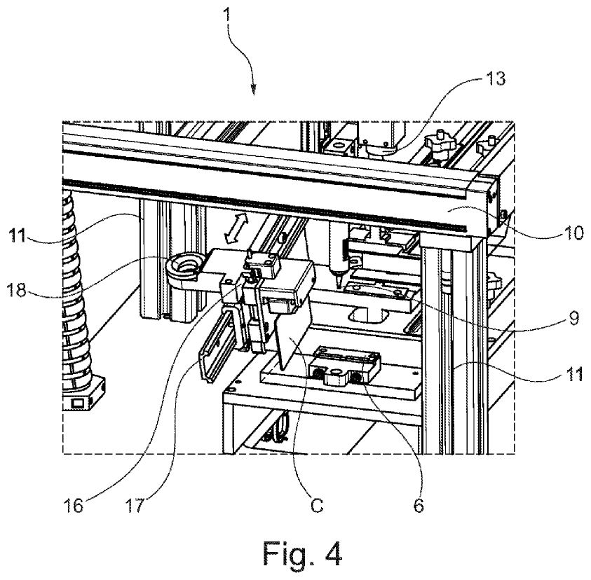

FIG. 4 shows a perspective view in detail of one advantageous embodiment of a test bench according to the invention;

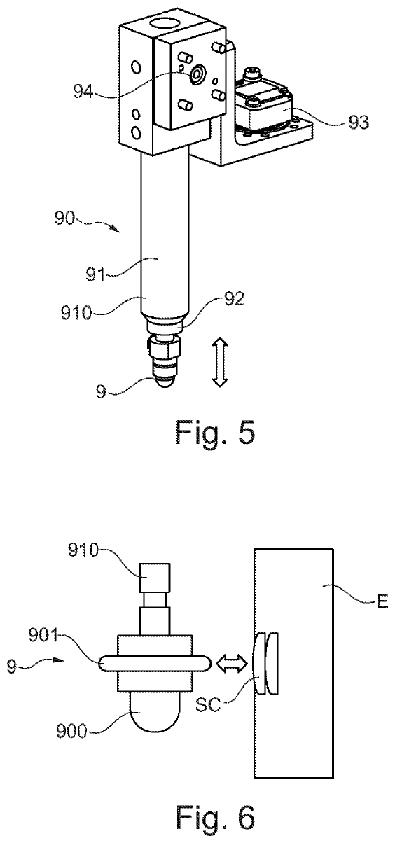

FIG. 5 shows a perspective view of one advantageous embodiment of a support finger for a probe incorporated into a test bench according to the invention;

FIG. 6 shows a schematic side view of one advantageous embodiment of a probe incorporated into a test bench according to the invention in test configuration by laterally pressing on a convex surface of a device;

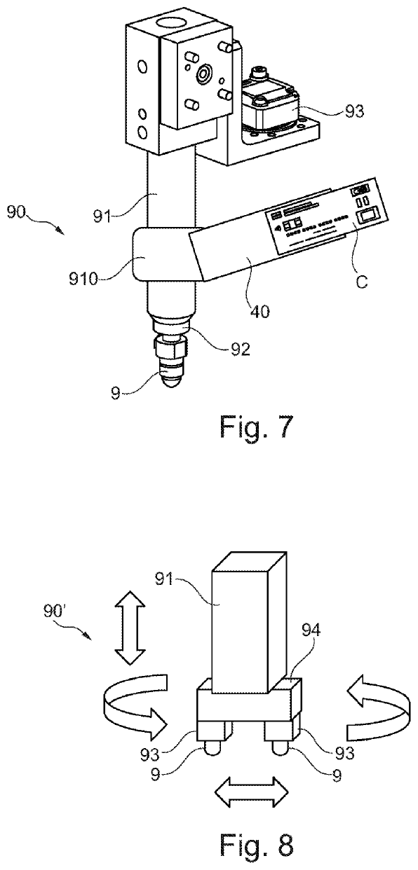

FIG. 7 is a perspective view of another advantageous embodiment of a support finger for a probe, on which is mounted another support for testing a specific device to be tested;

FIG. 8 is a schematic perspective view of another embodiment of a rotary support with two probes which can be separated from one another;

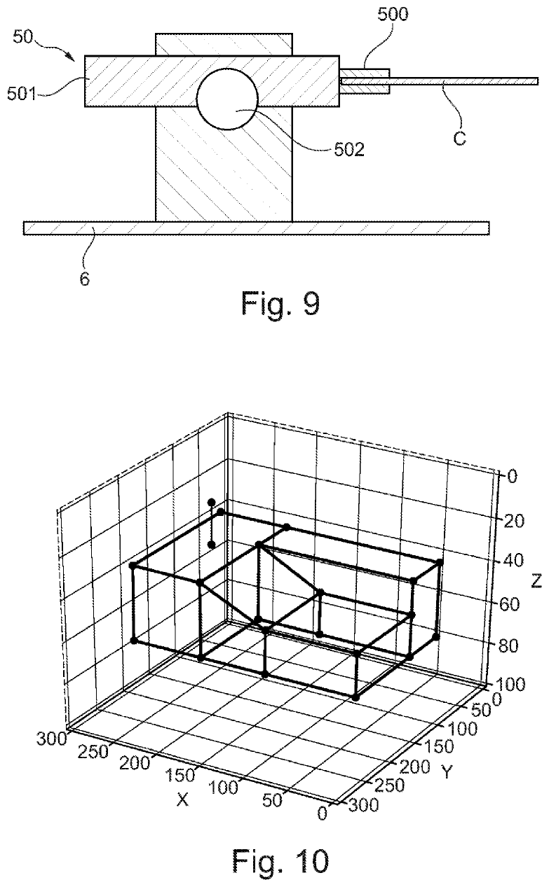

FIG. 9 is a diagram from the side of an additional module which can be incorporated into the test bench according to the invention and which is configured to insert a device to be tested of bank card type;

FIG. 10 is a view of a 3D graph illustrating an example of exclusion regions for the movement of a probe in the test bench according to the invention.

It is specified here that throughout the present application, the terms “lower”, “central”, “upper”, “above”, “below”, “inside”, “outside” are to be understood with reference to a probe according to the invention arranged vertically in a test bench according to the invention.

The arrows indicate the different possible movements for the probe and its support finger in the test bench.

FIG. 1 shows a non-intrusive, automated test bench, denoted as a whole by the reference 1.

The test bench 1 consists of a module with a frame 10 built from a plurality of profiles 11 and provided with feet 12. A central unit 2, an enclosure 3, an electrical box 4 for controlling the central unit and an external connector 5, preferably a 220 V power supply connector and/or an Ethernet-type connector, are secured to the frame.

The bottom of the enclosure 3 comprises a support 6 for holding the device to be tested in a fixed reference position, during test sequences.

Another power supply connector 7 that can supply the apparatus/device to be tested with power and be controlled is arranged close to the support 6.

The enclosure 3 comprises a plurality of transparent walls 30, one of which can be opened and constitutes, for an operator, a secure access to the support 6 from the outside. To facilitate access, the access wall 30 is provided with a handle P.

Electronic means 31 allowing the power supplies to be interrupted and, where applicable, the access door to be locked/unlocked are provided. In addition, an emergency button 32 secured to the frame 10 close to the access door allows an operator to interrupt any test in the event of an emergency.

A gantry supporting a Cartesian robot with three axes (X, Y, Z) 8 is secured inside the enclosure 3.

A probe 9 is secured to the gantry 8 which can therefore move the probe 9 in translation along each of the three axes X, Y and Z. The probe 9 can therefore come into contact as desired with any region of the device during the one or more tests, each region of contact constituting an acquisition interface (HMI). The probe 9 advantageously has both a mechanical and capacitive/resistive tip.

A camera 13 is also secured to the gantry 8. This camera makes it possible to take images and/or videos of the apparatus/device, more particularly of the one or more interfaces (HMI) for visual reproduction of the apparatus/device, during the one or more tests.

In order to control the lighting conditions inside the enclosure and therefore increase the quality of the images and/or of the video taken by the camera 13, lighting means 14 for illuminating the support for the apparatus/device are secured to the frame 10.

The central unit 2 can control the switching on, switching off and, where applicable, the adjustment of the intensity of the beam F of the lighting means 14 during the one or more sequences of one or more tests on the apparatus/device.

A microphone 15 is secured inside the enclosure 3. This microphone 15 is designed to pick up the sounds emitted by at least one sound reproduction interface of the apparatus/device, during the one or more tests.

The operation of the test bench 1 that has just been described will now be briefly explained.

The operator positions and, where applicable, secures the apparatus/device to be tested on/to the support 6.

Next, they connect a power supply of the apparatus/device to be tested to the power socket 7 that the central unit 2 can control.

The operator then closes the access door 30 of the enclosure 3 which is locked by the ad hoc means 31.

An apparatus/device test sequence may then be initiated.

Control software loaded into the central unit 2 has already retrieved or retrieves the list of tests to be executed in a dedicated language.

The software then controls and synchronizes all or some of the components inside the enclosure 3 according to a predefined test sequence: the gantry 8 forming a Cartesian robot with three axes and therefore the probe 9, the camera 13 and, where applicable, the lighting means 14, the microphone 15, and, where applicable, the electrical power socket.

The software then retrieves the functional information on the apparatus/device being tested.

In particular, the software can process images from the camera 13, preferably with OCR character recognition, 7 segments, 16 segments, and/or color recognition, and/or shape recognition, and/or icon recognition.

In addition, the software can process the sounds emitted by the apparatus/device being tested, in order to distinguish between the operations originating from the HMIs.

Ultimately, the software allows the results and actions of the tests performed to be put into a dedicated format, which can be stored in one or more files in the central unit 2 or in an external storage medium via the external connection 5.

In addition to the functions described, other test functions may be implemented on the bench 1 according to the invention, depending on the type of apparatus/device to be tested.

Thus, for example, if this apparatus/device is an electronic payment terminal, it is possible to set up, inside the enclosure 3, means for mechanically inserting an electronic payment card into the terminal.

One advantageous configuration for this mode is shown in FIG. 4.

In this FIG. 4, it is possible to see a carriage 16 slidably mounted on a rail 17 secured to the frame 10. The carriage 16 bears the payment card C to be inserted into the terminal.

The carriage 16 also bears a ring 18 into which the shaft of the probe 9 can be fitted so that the gantry can move the carriage on the rail 17 via the probe 9.

FIG. 5 shows, in detail, one advantageous embodiment of a support finger 90 for a probe 9 according to the invention.

The support finger 90 firstly comprises a tube 91 at the end of which is secured an adjustment device 92 allowing the travel and the force of the press performed by the probe 9, which is removably mounted at the end of the device 92, to be adjusted.

The lower portion 910 of the tube 91 can serve as a region for guiding a movement for an additional test module which might be added as described below.

The support finger 90 can also bear, in its upper portion, a camera 93 which is fixed with respect to the axis of movement Z and which therefore allows the regions of the equipment to be tested to be viewed as closely as possible.

Lastly, it is also possible to provide, in the upper portion of the support finger 90, a region 94 designed to bear a force gauge, in order to be able to accurately measure the force applied to the probe 9.

The diameter and the length of the tube 91 and of the probe 9 are advantageously close to those of a human finger in order to allow access to regions to be tested which may be recessed or in relief or which may be arranged on a lateral edge of the device to be tested.

By virtue of these features, the tests to be performed by the bench according to the invention may be implemented on devices having complex and non-planar surfaces.

One advantageous example of a probe 9 performing a test on a convex surface SC at the lateral edge of a device E is shown in FIG. 6. This convex surface SC may for example be that of a smartphone: it may be an on/off button, or a button for the volume (+/−).

Thus, the probe 9 comprises a tip 900 of capacitive/resistive/mechanical type, with a hemispherically shaped end, which will make it possible, with a movement along the Z axis, to test perpendicular regions, and an elastically deformable ring 901 which will make it possible to test complex regions, a convex surface SC in the example illustrated, which are not perpendicular to the axis Z.

An adaptation part, not illustrated, may be implemented so that the longitudinal axis of the probe 9 is horizontal, which allows it to be used on devices to be tested, in particular HMIs, arranged vertically.

Lateral movements of the probe 9 can be used to perform swiping movements and also to press side buttons.

For lateral pressing movements, the probe is equipped with a plastic ring making it possible to access a surface button or one that is convex with respect to the surface of the device being tested.

The axis of movement Z of the probe 9 which will perform a test press is preferably programmable with the torque being taken into account in order to apply a controlled force.

The support finger 90 can be equipped with a specific support, in order to hold an object needed to perform the test.

Such a specific support 40 mounted around the region 910 of the tube 91 is shown in FIG. 7. This support 40 can be used to hold a contactless payment card. Any other specific support may be considered, for example to bear a smartphone or a contactless payment card or any other device needed to perform a test.

In such a configuration, the movement of the finger 90 allows the device borne to be positioned in the test position or its rest position by virtue of movements along the axes X, Y and Z.

Instead of a finger support 90 with a single probe 9 at the end, another mechanism may be envisaged.

A rotary mechanism 90′ with a dual probe 9 is shown in FIG. 8.

This mechanism 90′ also comprises a tube 91 secured to the axis Z, two probes 9 that can be moved apart from one another or brought closer together by means of suitable devices 93 which can also be used to retract the probes 9 along the Z axis. 360° rotary movement is provided by an integrated mechanism 94.

Such a mechanism 90′ with a function of gripping by mutually moving the two probes 9 apart from one another or closer together makes it possible to perform tests with spreading movements between two regions, for example on a touchscreen (zoom function).

Such a mechanism 90′ also makes it possible to perform operations on rotary potentiometers, screwing and screwing control operations, etc.

The automated test bench according to the invention may be equipped with additional cameras. The functions offered by these additional cameras may be the following:

real-time recording of everything performed by the test bench on the device being tested,

analyzing displays on another screen which is not covered or poorly covered by the camera positioned on the axis Z;

continuously analyzing displays of the devices being tested, including during movement on the axes X, Y and Z.

FIG. 9 shows a module 50 for inserting a bank card with which the test bench can be equipped.

This module allows movements of inserting contact chip cards C into a reader to be to performed. Thus, the module 50 comprises a card support 500, the movement of which can be driven by a dedicated motor 501 or by means of the probe.

The card may be a standard bank card or a test probe. It is held mechanically with play allowing the force of insertion of the card at the end of travel to be controlled.

Switching the card is straightforward and requires no tools.

The position of the card with respect to the slot of the terminal is adjusted by referencing the module with respect to the base support 6, and by way of the inclination of the guide and of the height of the guide made possible by the integrated mechanism 502.

To perform the test, the control unit of the test bench 1 executes instructions in natural language in order to perform the following steps:

insertion of the card to be tested;

withdrawal of the card;

switching of the card;

calibration of card positions (insertion, withdrawal, slot position, switching position).

The module 50 may also be replaced with a module with the same kinematics which makes it possible to perform movements of presenting contactless chip cards to a reader. The movement can be driven by a dedicated motor or by means of the probe.

The card may be a standard bank card or a test probe.

Switching the contactless card is straightforward and requires no tools.

The position of the card with respect to the contactless reader of the terminal is adjusted in this case by referencing the module with respect to the base support 6, and by way of the inclination of the guide and of the height of the guide.

To perform the test, the control unit of the test bench 1 executes instructions in natural language in order to perform the following steps:

presentation of the card to be tested;

withdrawal of the card;

switching of the card;

calibration of card positions (insertion, withdrawal, slot position, switching position).

The control unit of the test bench 1 according to the invention is advantageously calibrated by the operator using a human-machine interface allowing names for positions X, Y and Z to be defined. These names can then be used by the operator in test scripts. They may for example correspond to the position of a mechanical or touch button.

The same calibration mechanism can be used to define movements: in this case, the operator defines two distinct positions, namely X1, Y1, Z1 and X2, Y2, Z2.

Since the device to be tested is position-referenced, calibration is carried out without taking into account a reference X=0, Y=0 and Z=0 corresponding to a particular point on the device to be tested. The reference is preferably given by the reference position of the controllers along the axes X, Y and Z.

Preferably, the definition for the test scripts entered into the control unit of the bench does not require any particular knowledge in software development or in robotics language. Indeed, the operator advantageously uses NLI natural language instructions corresponding to generic or specific commands for the bench.

Generic commands correspond to the use of calibrated positions or movements. For example, a command “position X, Y, Z” allows the probe to be positioned at X, Y, Z, “high camera position” allows the camera to be positioned at a position calibrated as the high position, “press green key” allows the calibrated movement for pressing the green button to be executed, “search for amount” searches for the word “amount” in the current image taken by the camera.

Specific commands correspond to the device being tested, and they are developed according to the needs of the operator. The operator can then use them to carry out their test scripts. For example, a specific instruction “insert card” allows a movement of inserting a chip card into a module simulating a payment terminal (handling the gripping of the card, the positions and the force of insertion) to be executed, and a specific command “generate 3 kg” allows an analog quantity representing a mass of 3 kg to be implemented.

Furthermore, the control unit of the bench is advantageously configured to adapt to any new apparatus/device to be tested, and in particular to take into account the mechanical characteristics of the device to be tested and its environment.

Thus, the control unit of the bench firstly comprises computer programs comprising a medium and, stored on this medium, instructions that are readable by a processor in order, when executed, to define exclusion regions into which the probe 9 and its support finger 90 are not allowed to move along the axes X, Y and Z.

FIG. 10 illustrates, with a three-dimensional graph, an example of exclusion regions defined for a probe.

The invention is not limited to the examples described; in particular, features of the examples illustrated may be combined with one another within variants that are not illustrated.

Other variants and improvements may be envisaged without departing from the scope of the invention.

In general, the automated test bench according to the invention with its control software loaded directly into the central unit allows all types of mechanical, software and/or audio tests to be performed in a non-intrusive manner on an electronic apparatus/device with one or more human-machine interfaces.

1. A non-intrusive automated test bench, intended to perform mechanical and/or software and/or audio tests on one or more human-machine interfaces (HMI) of an apparatus/device, comprising:
a support, designed to hold the apparatus to be tested in a fixed position, called the reference position, during at least one test of at least one sequence;
at least one probe, designed to come into contact with an acquisition interface (HMI) of the apparatus during the one or more tests;
at least one probe actuator, designed to move the probe in translation along at least one of three axes X, Y, Z; the actuator comprising a gantry forming a Cartesian robot with three axes, to which the probe is secured;
at least one microphone, designed to pick up sounds emitted by at least one sound reproduction interface of the apparatus/device, during the one or more tests;
at least one camera, designed to take images and/or videos of the apparatus/device during the one or more tests,
a central unit, designed to control the one or more probe actuators, the one or more microphones, in order to implement the one or more test sequences of the apparatus/device, and to process the images and/or videos of the apparatus/device, from the one or more cameras.

2. The automated test bench as claimed in claim 1, the camera being able to be fixed or to be secured to the gantry with three axes.

3. The automated test bench as claimed in claim 1, the probe comprising at least one palpation protuberance which extends laterally with respect to the axis Z and which is designed to perform pressing actions in a region at an edge of a main surface of the apparatus/device to be tested.

4. The automated test bench as claimed in claim 1, further comprising means for mechanical insertion and/or electrical connection and/or contactless reading of a component in the apparatus/device.

5. The automated test bench as claimed in claim 4, the mechanical insertion and/or electrical connection means comprising at least one rail on which a carriage on which the component can be held is slidably mounted.

6. The automated test bench as claimed in claim 4, the carriage bearing a ring into which the shaft of the probe can be fitted so that the gantry can move the carriage on the rail via the probe.

7. The automated test bench as claimed in claim 1, further comprising lighting means for illuminating the support for the apparatus/device.

8. The automated test bench as claimed in claim 7, the central unit being further designed to control the switching on, switching off and, where applicable, the adjustment of the intensity of the lighting means during the one or more sequences of one or more tests on the apparatus/device.

9. The automated test bench as claimed in claim 1, comprising at least one electrical power socket for the apparatus, the socket being designed to be controlled by the central unit during the one or more sequences of one or more tests on the apparatus/device.

10. The automated test bench as claimed in claim 1, the central unit of the test bench being configured to define exclusion regions into which the probe is not allowed to move along one and/or another of the three axes X, Y and Z.

11. The automated test bench as claimed in claim 1, comprising an enclosure comprising at least one secure access to the support for an operator from the outside, the enclosure being configured to house the support, the one or more probes and the one or more probe actuators, the one or more microphones, the one or more cameras and, where applicable, the gantry with three axes, and, where applicable, the means for mechanical insertion and/or electrical connection of a component in the apparatus/device, the lighting means for illuminating the support for the apparatus/device, and the one or more electrical power sockets for the electrical apparatus/device.

12. The automated test bench as claimed in claim 11, comprising a frame to which are secured the central unit, the enclosure, an electrical box for controlling the central unit and an external connector.

13. The use of the automated test bench as claimed in claim 1, to perform at least one non-intrusive test in at least one sequence on an apparatus/device chosen from a smartphone, an electronic payment terminal, a measurement or metrology indicator, an embedded medical device, an IOT object equipped with a screen and a keyboard, a device for an instrument panel, an interactive terminal, a connected watch, a portable video game console, a car radio, an industrial control panel.
